(19) United States
(12) Patent Application Publication
(10) Pub. No.: US 2017/0197544 A1
(43) Pub. Date: Jul. 13, 2017

(54) Vehicle Communication Device, Vehicle Communication Method, and Vehicle

(71) Applicants: BOE Technology Group Co., Ltd., Beijing (CN); Beijing BOE Optoelectronics Technology Co., Ltd., Beijing (CN)

(72) Inventors: Zhiyong Wang, Beijing (CN); Shuai Xu, Beijing (CN); Hong Zhu, Beijing (CN)

(21) Appl. No.: 15/252,977

(22) Filed: Aug. 31, 2016

(30) Foreign Application Priority Data
Jan. 13, 2016 (CN) 201610022318.9

(51) Int. Cl. B60Q 1/50; G06K 9/32; G06K 9/00; G06K 19/06; G06T 1/20

(52) U.S. Cl. CPC B60Q 1/503; G06K 19/06037; G06T 1/20; G06K 9/00791; G06K 9/3258

(57) ABSTRACT

There are provided in the present disclosure a vehicle communication device and method, and a vehicle. Herein, the device comprises: a processing unit and a display unit. The processing unit is configured to generate first information according to at least one of breakdown information, congestion information, GPS information, vehicle information and personalization information; and the display unit is configured to display the first information. The device comprises: an image acquisition unit, a processing unit and a display unit. The image acquisition unit is configured to acquire first information displayed by other vehicle; the processing unit is configured to process the first information, present the processed information to the user, and generate second information according to at least one of identification information of a current vehicle and user additional information as well as the first information; and the display unit is configured to display the second information.

This application claims priority to and the benefit of Chinese Patent Application No. 201610022318.9 filed on Jan. 13, 2016, which application is incorporated herein in its entirety.

### TECHNICAL FIELD

The present disclosure relates to a field of display on vehicle technique, in particular to a vehicle communication device, a vehicle communication method, and a vehicle.

### BACKGROUND

As people's living standard is raised, an automobile, as an important means of transportation, has emerged in millions of households gradually. An automobile is always mounted with a vehicle-mounted terminal to provide diversified services for a driver, for example, checking driving data information, and providing multimedia services such as real-time traffic signal, map navigation, music and video or the like. In general, the vehicle-mounted terminal needs to be mounted with a wireless communication module (i.e., vehicle communication module) to be accessed to wireless network and to perform wireless communication with a vehicle monitoring system. In the driving process of the automobile, the vehicle-mounted terminal can feed back acquired vehicle status information to the vehicle monitoring system through a vehicle communication module, so as to realize that the vehicle monitoring system monitors vehicle statue in real time.

However, when the vehicle breaks down or congested traffic occurs, the existing vehicle-mounted terminal is unable to seek rescue efficiently or to spread the breakdown or congested traffic effectively and rapidly.

### SUMMARY

With respect to defects in the prior art, there are provided in the present disclosure a vehicle communication device, a vehicle communication method, and a vehicle, which are capable of displaying information such as breakdown or congested traffic and so on and transmitting the information effectively and rapidly.

According to one aspect of the embodiments of the present disclosure, there is provided a vehicle communication device, comprising: a processing unit and a display unit. The processing unit is configured to generate first information according to at least one of breakdown information, congestion information, GPS information, vehicle information and personalization information. The display unit is configured to display the first information.

According to the embodiment of the present disclosure, the first information includes at least one of two-dimensional code information and text information.

According to the embodiment of the present disclosure, the first information includes at least one of two-dimensional code information, text information and image information.

According to the embodiment of the present disclosure, the device further comprises: an emitting unit. The emitting unit is disposed in the periphery of the display unit and configured to emit light spectrum at a preset frequency band.

According to the embodiment of the present disclosure, the processing unit comprises: a graphic processing unit GPU and an input interface. The input interface is configured to receive the personalization information; the personalization information includes at least one of text information, image information and audio information. The GPU is configured to generate the first information for displaying according to at least one of breakdown information, congestion information, GPS information, vehicle information and personalization information.

According to the embodiment of the present disclosure, the personalization information is produced by a user of the vehicle communication device.

According to a second aspect of the embodiments of the present disclosure, there is provided a vehicle communication device, comprising: an image acquisition unit, a processing unit and a display unit. The image acquisition unit is configured to acquire first information displayed by other vehicle. The processing unit is configured to process the first information, present the processed information to the user, and generate second information according to at least one of identification information of a current vehicle and user additional information as well as the first information. The display unit is configured to display the second information.

According to the embodiment of the present disclosure, the first information includes: at least one of two-dimensional code information and text information, and the second information includes at least one of two-dimensional code information and text information.

According to the embodiment of the present disclosure, the first information includes at least one of two-dimensional code information, text information and image information, and the second information includes at least one of two-dimensional code information, text information and image information.

According to the embodiment of the present disclosure, the image acquisition unit comprises: a detector and a camera. The detector is configured to receive light spectrum emitted by an emitting unit of other vehicle and position a display unit of the other vehicle according to the light spectrum. The camera is configured to take a photograph of a positioned display unit, to obtain first information displayed on the display unit of the other vehicle.

According to the embodiment of the present disclosure, the processing unit comprises: an input interface, a decoder and a graphic processing unit GPU. The input interface is configured to receive at least one of text information, image information and audio information, so as to generate user additional information. The decoder is configured to decode two-dimensional code information in the first information, so as to present decoded information to the user. The GPU is configured to generate second information for displaying according to at least one of identification information of a current vehicle and user additional information as well as the first information.

According to the embodiment of the present disclosure, the device further comprises: a storage unit. The storage unit is configured to store a decoding dictionary. Additionally, the storage unit can further store at least one of first information, second information and user additional information.

According to a third aspect of the embodiments of the present disclosure, there is provided a vehicle, comprising the vehicle communication device described above.

Preferably, a display unit of the vehicle comprises: a front window and a rear window. A projector is disposed on the front window to project and display first information or second information. The rear window is a transparent display for displaying the first information or the second information.

According to a fourth aspect of the embodiments of the present disclosure, there is provided a vehicle communication method, comprising: generating, by a processing unit, first information according to at least one of breakdown information, congestion information, GPS information, vehicle information and personalization information, and transmitting the first information to a display unit; and displaying, by the display unit, the first information.

According to the embodiment of the present disclosure, the first information includes at least one of two-dimensional code information and text information. According to the embodiment of the present disclosure, the first information includes at least one of two-dimensional code information, text information and image information.

According to the embodiment of the present disclosure, at least one emitting unit is disposed in the periphery of the display unit. The method further comprises: emitting, by the at least one emitting unit, light spectrum at a preset frequency band at regular time.

According to the embodiment of the present disclosure, said generating, by the processing unit, first information according to at least one of breakdown information, congestion information, GPS information, vehicle information and personalization information comprises: receiving, by the processing unit, the personalization information; the personalization information including at least one of text information, image information and audio information; and generating the first information for displaying according to at least one of the breakdown information, the congestion information, the GPS information, the vehicle information and the personalization information.

According to a fifth aspect of the embodiments of the present disclosure, there is provided a vehicle communication method, comprising: said acquiring, by an image acquisition unit, first information displayed other vehicle; processing, by the processing unit, the first information, and presenting the processed information to a user; generating second information according to at least one of identification information of a current vehicle and user additional information as well as the first information; and displaying, by a display unit, the second information;

According to the embodiment of the present disclosure, the first information includes at least one of two-dimensional code information and text information, and the second information includes at least one of two-dimensional code information and text information.

According to the embodiment of the present disclosure, the first information includes at least one of two-dimensional code information, text information and image information, and the second information includes at least one of two-dimensional code information, text information and image information.

According to the embodiment of the present disclosure, said acquiring, by an image acquisition unit, first information displayed by other vehicle comprises: receiving, by the image acquisition unit, light spectrum emitted by an emitting unit of the other vehicle through a detector, and positioning a display unit of the other vehicle according to the light spectrum; and taking a photograph, by a camera, the positioned display unit, to obtain first information displayed on the display unit of the other vehicle.

According to the embodiment of the present disclosure, said generating, by the processing unit, second information according to at least one of identification information of a current vehicle and user additional information as well as the first information comprises: receiving at least one of text information, image information and audio information through an input interface, and generating the user additional information; decoding two-dimensional code information in the first information through a decoder, so as to prompt the decoded information to the user; and generating the second information for displaying according to at least one of identification information of a current vehicle and the user additional information as well as the first information through a GPU.

According to the embodiment of the present disclosure, the method further comprises: storing, by a storage unit, a decoding dictionary. Additionally, the storage unit can further store the first information, the second information and the user additional information.

It can be known from the above technical solutions that the present disclosure is capable of integrating at least one of traffic information such as congestion information, breakdown rescue information of the current vehicle, GPS information, vehicle information and personalization through the processing unit, so as to generate the first information. Thus, the first information is further transmitted to the display unit, so that the display unit displays the first information. In this way, traffic condition would be published and vehicle breakdown would be rescued through the vehicle communication device provided in the present disclosure.

In the vehicle communication device provided in the present disclosure, when the image acquisition unit acquires the first information displayed by the display unit of the other vehicle, the processing unit processes the first information to present to the user, so as to prompt the user whether to give a rescue or forward the information. If the user cannot give a rescue or the user selects to forward the information, then at this time, the second information is generated according to at least one of identification information of a current vehicle and user additional information as well as the first information, and the second information would be displayed on the display unit for information transmission, so as to forward and transmit breakdown information or traffic information rapidly.

The present disclosure establishes a social solution of a “word-of-mouth communication” mode through simulating a social information transmission mode by means of a huge amount of automobiles and a close relationship between the automobile and the driver. It can be either applied to a rescue mode in a remote region or applied to fast transmission traffic in a congested urban road.

### BRIEF DESCRIPTION OF THE DRAWINGS

In order to describe technical solutions in embodiments of the present disclosure or in the prior art clearly, drawings used in description of the embodiments or the prior art will be introduced briefly. Obviously, the drawings described below are just some embodiments of the present disclosure. For those ordinary skilled in the art, other drawings can be obtained from these drawings without paying any inventive labor.

FIG. 1 is a schematic diagram of a structure of a vehicle communication device provided in an embodiment of the present disclosure;

FIG. 2 is a schematic diagram of a display unit provided in another embodiment of the present disclosure;

FIG. 3 is a schematic diagram of a structure of a vehicle communication device provided in another embodiment of the present disclosure;

FIG. 4 is a schematic diagram of a structure of a vehicle communication device provided in another embodiment of the present disclosure;

FIG. 5 is a schematic diagram of a structure of a vehicle communication device provided in another embodiment of the present disclosure;

FIG. 6 is a schematic diagram of a front window display unit of a vehicle provided in another embodiment of the present disclosure;

FIG. 7 is a schematic diagram of a rear window display unit of a vehicle provided in another embodiment of the present disclosure;

FIG. 8 is a schematic flowchart of a vehicle communication method provided in an embodiment of the present disclosure;

FIG. 9 is a schematic flowchart of a vehicle communication method provided in another embodiment of the present disclosure.

### DETAILED DESCRIPTION

Technical solutions in embodiments of the present disclosure will be described clearly and completely by combining with drawings in the embodiments of the present disclosure. Obviously, the embodiments described below are just a part of embodiments of the present disclosure, but not all of the embodiments. Based on the embodiments in the present disclosure, all the other embodiments obtained by those ordinary skilled in the art without paying any inventive labor belong to the scope sought for protection in the present disclosure.

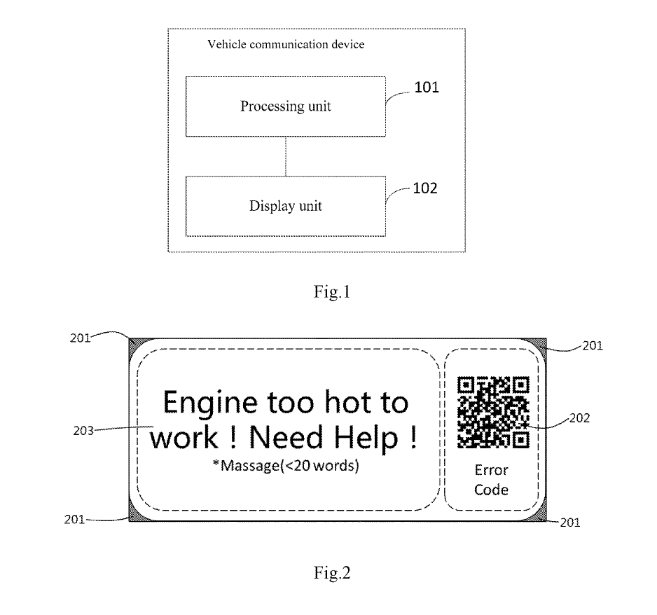

FIG. 1 is a schematic diagram of a structure of a vehicle communication device provided in an embodiment of the present disclosure. As shown in FIG. 1, the vehicle communication device comprises: a processing unit 101 and a display unit 102.

The processing unit 101 generates first information according to at least one of breakdown information or congestion information, GPS information, vehicle information and personalization information. The display unit 102 displays the first information.

In particular, the vehicle information includes but not limited to built-in information of the vehicle, identification information of the vehicle, etc. The personalization information includes but not limited to voice information, image information, inputted text information, etc. For example, the display unit in the present embodiment may be a front windshield window or a rear windshield window of a vehicle. In this way, the first information can be displayed directly on the front windshield window or the rear windshield window.

Further, the first information is generated by integrating at least one of the breakdown information, congestion information, GPS information, vehicle information and personalization information. In particular, the first information includes at least one of two-dimensional code information and text information. Or, the first information includes at least one of two-dimensional code information, text information, and image information. As shown in FIG. 2, the first information is displayed in the display unit. The first information is displayed in an area defined by a display unit area 201. The first information includes text information 203 and two-dimensional code information 202. In this way, breakdown information or congestion information or the like can be described or reflected intuitively through this first information, such that the breakdown information or congestion information or the like is transmitted effectively.

Thus it can be seen that the vehicle communication device provided in the embodiment of the present disclosure is capable of integrating at least one of traffic information such as congestion information, breakdown rescue information of the current vehicle, GPS information, vehicle information and personalization information through the processing unit 101, to generate the first information. Further, the first information is transmitted to the display unit 102, so that the display unit 102 displays the first information. In this way, the vehicle communication device in the present embodiment is capable of publishing the traffic condition and rescuing the breakdown and so on effectively.

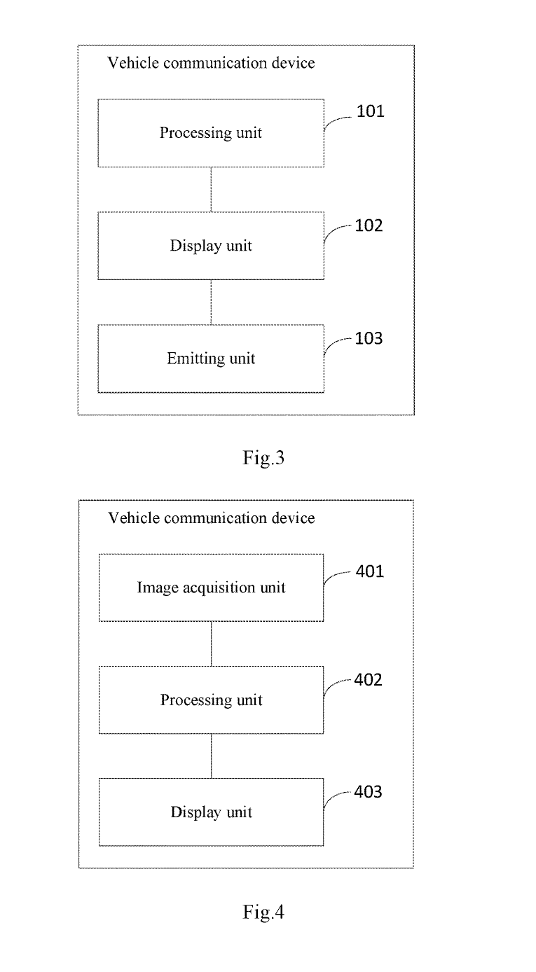

Further, besides the processing unit 101 and the display unit 102 in the above embodiment, the vehicle communication device as shown in FIG. 3 further comprises: an emitting unit 103.

The emitting unit 103 is disposed in the periphery of the display unit 102 and configured to emit light spectrum at a preset frequency band.

For example, the emitting unit 103 can be disposed at four corners of the display unit 102, and is configured to emit light spectrum at a specific infrared frequency band.

In this way, the present embodiment disposes the emitting unit 103 in the periphery of the display unit 102, so that the display unit 102 of the vehicle is capable of being positioned by a detector of other vehicle, so as to realize positioning and photographing of the specific content on the display unit 102 of the vehicle, thereby obtaining the specific content of the display unit 102.

In particular, the processing unit 101 comprises: a graphic processing unit GPU and an input interface.

The input interface is configured to receive the personalization information; the personalization information includes at least one of text information, image information and audio information.

It needs to be noted that the processing unit 101 can comprise a plurality of input interfaces, such as an audio input interface, an image input interface, and a text input interface (connected to an additional keyboard), etc., so as to obtain the personalization information and thus determine a part of content displayed on the display unit 102. According to the embodiment of the present disclosure, the personalization information is produced by a user of the vehicle communication device.

The GPU generates the first information for displaying according to at least one of breakdown information, congestion information, GPS information, vehicle information and personalization information.

In particular, the GPU generates information displayed on the display unit according to the first information generated by integrating at least one of breakdown information, congestion information, GPS information, vehicle information and personalization information.

FIG. 4 is a schematic diagram of a structure of a vehicle communication device provided in another embodiment of the present disclosure. As shown in FIG. 4, the device comprises: an image acquisition unit 401, a processing unit 402, and a display unit 403.

The image acquisition unit 401 is configured to acquire first information displayed by other vehicle; the processing unit 402 is configured to process the first information, present the processed information to the user, and generate second information according to at least one of identification information of the vehicle and user additional information as well as the first information; and the display unit 403 is configured to display the second information.

The first information includes at least one of two-dimensional code information and text information, and the second information includes at least one of two-dimensional code information and text information.

According to the embodiment of the present disclosure, the first information includes at least one of two-dimensional code information, text information and image information, and the second information includes at least one of two-dimensional code information, text information and image information.

It needs to be noted that display of the second information may be cancelled depending on the user's selection, or may be canceled automatically after a predetermined period of time.

It could be understood that the first information is information displayed on the display unit of other vehicle. In particular, it may be first information generated by the other vehicle according to at least one of its own breakdown information, congestion information, GPS information, vehicle information and personalization information, or may be first information displayed by another vehicle and forwarded by the other vehicle.

In particular, when the image acquisition unit 401 acquires the first information displayed on the display unit of other vehicle, the processing unit 402 processes the first information to obtain breakdown information or congestion information, so as to present the information to the user and prompt to the user whether to give a rescue or forward the information. If the user cannot give a rescue or selects to forward the information, then at this time, the second information is generated according to at least one of identification information of the current vehicle and user additional unit as well as the first information, and the second information is displayed on the display unit 403 for information transmission, so as to realize forwarding breakdown information or traffic information.

In particular, the image acquisition unit 401 comprises: a detector and a camera.

The detector is configured to receive light spectrum emitted by the emitting unit of the other vehicle, and position the display unit of the other vehicle according to the light spectrum.

For example, based on the light spectrum at the infrared frequency band emitted by the emitting unit in the periphery of the display unit of other vehicle, the detector can position the display unit and instruct the camera to photograph automatically.

The camera is configured to take a photograph of the positioned display unit, so as to obtain the first information displayed on the display unit of the other vehicle.

It needs to be noted that pixel values of the positioned display unit area can be processed and compared with a preset value. When the pixel value of the display unit area reaches the preset value, the camera takes a photograph, so as to make the obtained image information clear enough and facilitate subsequent processing.

In particular, the processing unit 402 comprises: an input interface, a decoder and a graphic processing unit GPU.

The input interface is configured to receive at least one of text information, image information and audio information, so as to generate the user additional information. It needs to be noted that the processing unit 402 can comprise a plurality of input interfaces, such as audio input interface, image input interface, text input interface (connected to an additional keyboard), etc., so as to obtain the user additional information and determine a part of content of the second information displayed on the display unit 403.

The decoder is configured to decode two-dimensional code information in the first information, so as to present the decoded information to the user.

In particular, the two-dimensional code information in the first information can be decoded based on a built-in decoding dictionary, and the encoded content is recovered to obtain breakdown information or congestion information, GPS information, vehicle information and personalization information and so on of a breakdown vehicle or a congested vehicle, so as to further know the breakdown information or the congestion information, thereby determining whether to rescue the breakdown vehicle or forward the breakdown information or whether to forward the congestion information so as to avoid excessive congestion.

The GPU is configured to generate the second information for displaying according to at least one of identification information of the current vehicle and the user additional information as well as the first information. That is, when the current vehicle forwards the received first information, the identification information and/or the user additional information is added to the first information so as to obtain the second information.

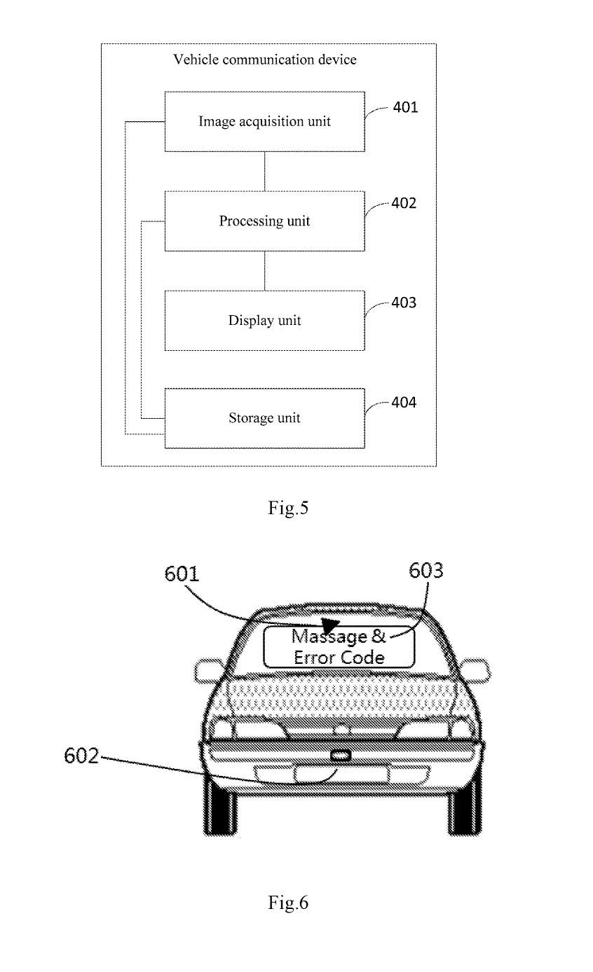

Further, besides the image acquisition unit 401, the processing unit 402, the display unit 403 in the above embodiment, the vehicle communication device as shown in FIG. 5 further comprises: a storage unit 404.

The storage unit 404 is configured to store the decoding dictionary. In addition, the storage unit can also store at least one of the first information, the second information and the user additional information. In particular, the image acquisition unit 401 and the processing unit 402 can share this storage unit 404.

There is provided a vehicle in another embodiment of the present disclosure, comprising: the vehicle communication device in the embodiment as shown in FIG. 1 and/or the vehicle communication device in the embodiment as shown in FIG. 4. In particular, the vehicle can be configured to generate the first information, or can be configured to generate the second information according to the first information displayed by other vehicle, and the vehicle can display the generated first information and second information. The vehicle generates and displays the second information according to the first information displayed by the other vehicle, so that forwarding of the first information displayed by the other vehicle can be realized.

In particular, the display unit of the vehicle comprises: a front window and a rear window.

FIG. 6 shows a schematic diagram of head of a vehicle. A front window 603 is disposed with a projector to project and display the first information and the second information for providing information to a coming vehicle. It needs to be noted that a camera lens 602 in the camera of the processing unit can be disposed as shown in FIG. 6.

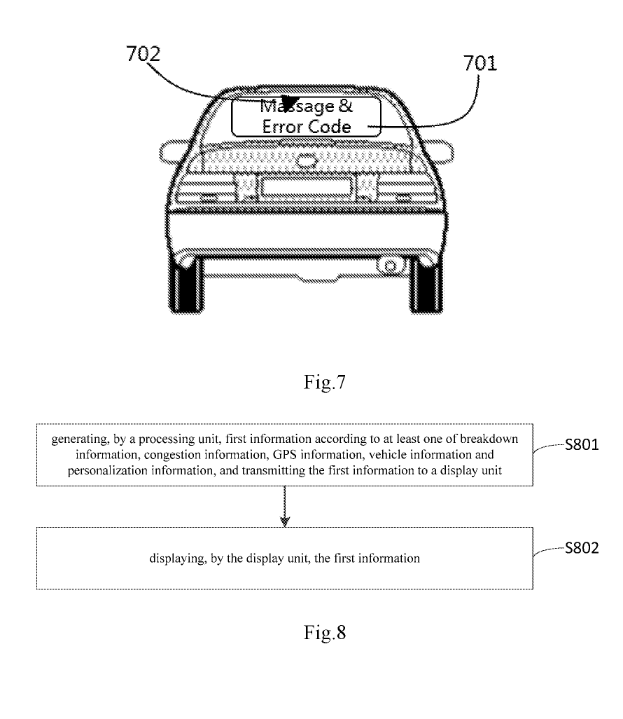

FIG. 7 shows a schematic diagram of rear of a vehicle as shown in FIG. 7. A rear window 701 is a transparent display and is configured to display the first information and second information generated for providing information to the following vehicle, or the rear window 701 can be also disposed with a projector 701 to project and display the first information or the second information for providing information to the following vehicle.

For example, when the vehicle breaks down, a vehicle computer of the vehicle would generate automatically breakdown information, GPS address, vehicle information and personalization information into a rescue code (a two-dimensional code) and display it on the front and rear windshield. After detecting this information automatically, a following vehicle or a coming vehicle prompts the driver whether to give a rescue or forward the information. If the driver in the following vehicle or the driver in the coming vehicle is unable to give a rescue or selects to forward the information, he/she can “forward” the rescue code to the rear windshield of the current vehicle and add identification of the current vehicle, so that effective transmission of the rescue information can be achieved. Information forwarding can be cancelled artificially, or cancelled automatically after a small period of time. In addition, a social transmission mode can be simulated, so that duration of time over forwarding at each time is reduced gradually.

For example, when urban transport is congested, a vehicle nearby a location where congestion occurs publishes initial congestion information and adds a GPS address. Then, the following vehicle forwards this information in time, so that the vehicle would be avoided from excessive congestion.

Thus it can be seen that the present embodiment establishes a social solution of a “word-of-mouth communication” mode through simulating a social information transmission mode by means of a huge amount of automobiles and a close relationship between the automobile and the driver. It can be either applied to a rescue mode in a remote region or applied to fast transmission of traffic in a congested urban road.

FIG. 8 is a flowchart of a vehicle communication method provided in an embodiment of the present disclosure. As shown in FIG. 8, the method comprises following steps: S801: generating, by a processing unit, first information according to at least one of breakdown information, congestion information, GPS information, vehicle information and personalization information, and transmitting the first information to a display unit; S802: displaying, by the display unit, the first information.

According to the embodiment of the present disclosure, the first information includes at least one of two-dimensional code information and text information. According to the embodiment of the present disclosure, the first information includes at least one of two-dimensional code information, text information and image information.

In the present embodiment, at least one emitting unit is disposed in periphery of the display unit.

Correspondingly, the method further comprises the following step not shown in FIG. 8: S803: emitting, by the at least one emitting unit, light spectrum at a predetermined frequency band at regular time.

The vehicle communication method provided in the present embodiment generates the first information by integrating at least one of traffic information such as congestion information, breakdown rescue information of the vehicle, GPS information, vehicle information and personalization information. Thus, the first information is transmitted to the display unit, so that the display unit displays the first information. In this way, traffic condition would be published and vehicle breakdown would be rescued effectively through the vehicle communication method provided in the present disclosure.

In the present embodiment, said generating, by a processing unit, first information according to at least one of breakdown information, congestion information, GPS information, vehicle information and personalization information in step S801 comprises following sub-steps: A01: receiving, by the processing unit, the personalization information; the personalization information comprises at least one of text information, image information and audio information; A02: generating the first information for displaying according to at least one of breakdown information, congestion information, GPS information, vehicle information and personalization information.

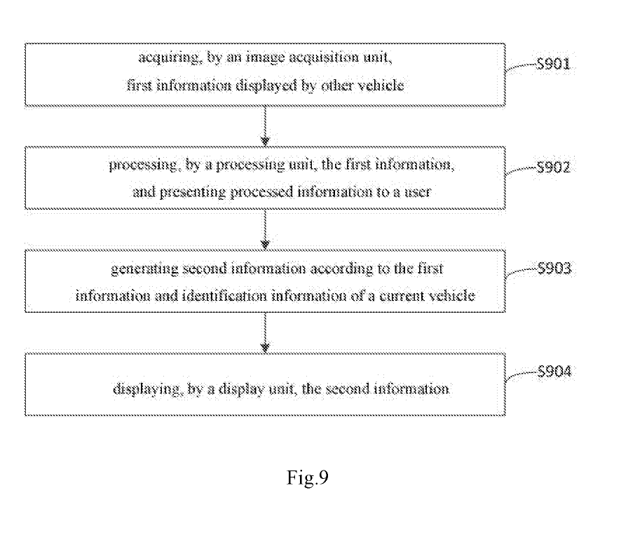

FIG. 9 is a flowchart of a vehicle communication method provided in another embodiment of the present disclosure. As shown in FIG. 9, the method comprises following steps: S901: acquiring, by an image acquisition unit, first information displayed by other vehicle; S902: processing, by a processing unit, the first information, and presenting the processed information to a user; S903: generating second information according to at least one of identification information of a current vehicle and user additional information as well as the first information; and S904: displaying, by a display unit, the second information.

According to the present embodiment of the present disclosure, the first information includes at least one of two-dimensional code information and text information, and the second information includes at least one of two-dimensional code information and text information.

According to the embodiment of the present disclosure, the first information includes at least one of two-dimensional code information, text information, and image information, and the second information includes at least one of two-dimensional code information, text information, and image information.

In the vehicle communication method provided in the present disclosure, when the image acquisition unit acquires the first information displayed by the display unit of the other vehicle, the processing unit processes the first information to present to the user, so as to prompt the user whether to give a rescue or forward the information. If the user cannot give a rescue or the user selects to forward the information, then at this time, the second information is generated according to at least one of identification information of the vehicle and user additional information as well as the first information, and the second information is displayed on the display unit for information transmission, so as to forward and transmit breakdown information or traffic information rapidly.

In particular, said acquiring, by the image acquisition unit, first information displayed by other vehicle at step S901 in particular comprises following sub-steps: B01: receiving, by the image acquisition unit, light spectrum emitted by an emitting unit of the other vehicle through a detector, and positioning a display unit of the other vehicle according to the light spectrum; B02: taking a photograph of the positioned display unit through a camera, and obtaining the first information displayed on the display unit of the other vehicle.

In the present embodiment, said processing, by the processing unit, the first information, presenting the processed information to the user, and generating second information according to at least one of identification information of the current vehicle and user additional information as well as the first information in particular comprises: C01: receiving text information, image information and audio information through an input interface, and generating the user additional information; CO2: decoding two-dimensional code information in the first information through a decoder, to prompt the decoded first information to the user; and CO3: generating second information for displaying according to at least one of identification information of the current vehicle and the user additional information as well as the first information through the GPU.

Further, the method further comprises the following step not shown in FIG. 9: S905: storing, by a storage unit, a decoding dictionary. In addition, the storage unit can further store the first information, the second information and the user additional information.

For the method embodiment, since it is basically similar to the device embodiment, its description is relatively simple. Where relevant, please see the part of description of the device embodiment.

In the description of the present disclosure, it needs to specify that orientations or position relationship indicated by terms “up”, “down”, etc. are orientations or position relationship shown based on the drawings, and are only used to describe the present disclosure conveniently and simplify the description, but not indicate or suggest the referred device or element must have a specific orientation and must be constructed and operated in a specific orientation, and thereby cannot be understood as a limitation of the present disclosure. Unless otherwise prescribed and limited, terms of “mount”, “connect” shall be understood broadly, for example, it may be connected fixedly, connected removably, or connected all-in-one; it may be connected mechanically, or connected electrically; it may be connected directly, or connected via an intermediate medium, or connected internally within two elements. For those skilled in the art, the meanings of the terms in the present disclosure can be understood according to the actual situation.

It should be noted that, in this specification, terms like “first” and “second” are only used to differentiate one entity or operation from another, but are not necessarily used to indicate any practical relationship or order between these entities or operations. Moreover, terms such as “include”, “comprise” or any variation of the terms mean “including but not limited to”. Therefore, a process, method, object, or device that includes a series of elements not only includes these elements, but also includes other elements that are not specified expressly, or may further include inherent elements of the process, method, object or device. In the case that there are no more limitations, in the context of a element that is defined by “includes one . . . ”, the process, method, object or device that includes the element may include other identical elements.

The above embodiments are only used to illustrate the technical solution of the present disclosure, which is not intended to limit the disclosure. Although the above embodiments have described the present disclosure in detail, those of ordinary skill in the art should understand that: they can still make modification or equivalent replacement to the technical solutions of the above embodiments; and the modification, or equivalent replacement does not render the technical solution of each embodiment in the present disclosure departing from the spirit and principle of the present disclosure.

What is claimed is:

1. A vehicle communication device, comprising: a processing unit and a display unit;
the processing unit is configured to generate first information according to at least one of breakdown information, congestion information, GPS information, vehicle information and personalization information; and
the display unit is configured to display the first information.

2. The vehicle communication device according to claim 1, wherein
the first information includes at least one of two-dimensional code information and text information; or
the first information includes at least one of two-dimensional code information, text information and image information.

3. The vehicle communication device according to claim 1, further comprising: an emitting unit;
the emitting unit is disposed in the periphery of the display unit and is configured to emit light spectrum at a preset frequency band.

4. The vehicle communication device according to claim 1, wherein the processing unit comprises: a graphic processing unit GPU and an input interface;
the input interface is configured to receive the personalization information; the personalization information including at least one of text information, image information and audio information;
the GPU is configured to generate the first information for displaying according to at least one of the breakdown information, the congestion information, the GPS information, the vehicle information and the personalization information.

5. A vehicle communication device, comprising: an image acquisition unit, a processing unit and a display unit;
the image acquisition unit is configured to acquire first information displayed by other vehicle;
the processing unit is configured to process the first information, present the processed information to the user, and generate second information according to at least one of identification information of a current vehicle and user additional information as well as the first information; and
the display unit is configured to display the second information.

6. The vehicle communication device according to claim 5, wherein
the first information includes at least one of two-dimensional code information and text information, and the second information includes at least one of two-dimensional code information and text information; or
the first information includes at least one of two-dimensional code information, text information and image information, and the second information includes at least one of two-dimensional code information, text information and image information.

7. The vehicle communication device according to claim 5, wherein the image acquisition unit comprises: a detector and a camera;
the detector is configured to receive light spectrum emitted by an emitting unit of other vehicle and position a display unit of the other vehicle according to the light spectrum; and
the camera is configured to take a photograph of the positioned display unit, to obtain the first information displayed on the display unit of the other vehicle.

8. The vehicle communication device according to claim 5, wherein the processing unit comprises: an input interface, a decoder and a graphic processing unit GPU;
the input interface is configured to receive at least one of text information, image information and audio information, so as to generate the user additional information;
the decoder is configured to decode two-dimensional code information in the first information, so as to present the decoded first information to the user; and
the GPU is configured to generate the second information for displaying according to at least one of the identification information of a current vehicle and the user additional information as well as the first information.

9. The vehicle communication device according to claim 8, wherein the device further comprises: a storage unit;
the storage unit is configured to store a decoding dictionary.

10. A vehicle, comprising: at least one of the vehicle communication device according to claim 1 and the vehicle communication device according to claim 5.

11. The vehicle according to claim 10, wherein the display unit of the vehicle comprises:
a front window and a rear window;
the front window is disposed with a projector to project and display the first information or the second information;
the rear window is a transparent display for displaying the first information or the second information.

12. A vehicle communication method, comprising:
generating, by a processing unit, first information according to at least one of breakdown information, congestion information, GPS information, vehicle information and personalization information, and transmitting the first information to a display unit; and
displaying, by the display unit, the first information.

13. The method communication device according to claim 12, wherein
the first information includes at least one of two-dimensional code information and text information; or
the first information includes at least one of two-dimensional code information, text information and image information.

14. The method communication device according to claim 12, wherein the periphery of the display unit is disposed with at least one emitting unit;
the method further comprises:
emitting, by the at least one emitting unit, light spectrum at a preset frequency band at regular time.

15. The method communication device according to claim 12, wherein said generating, by the processing unit, first information according to at least one of breakdown information, congestion information, GPS information, vehicle information and personalization information comprises:
receiving, by the processing unit, the personalization information; the personalization information including at least one of text information, image information and audio information; and
generating the first information for displaying according to at least one of the breakdown information, the congestion information, the GPS information, the vehicle information and the personalization information.

16. A vehicle communication method, comprising:
acquiring, by an image acquisition unit, first information displayed by other vehicle;
processing, by a processing unit, the first information, and presenting the processed information to a user;
generating second information according to at least one of identification information of a current vehicle and user additional information as well as the first information; and
displaying, by a display unit, the second information.

17. The method communication device according to claim 16, wherein
the first information includes at least one of two-dimensional code information and text information, and the second information includes at least one of two-dimensional code information and text information; or
the first information includes at least one of two-dimensional code information, text information and image information, and the second information includes at least one of two-dimensional code information, text information and image information.

18. The method communication device according to claim 16, wherein said acquiring, by an image acquisition unit, first information displayed by other vehicle comprises:
receiving, by the image acquisition unit, light spectrum emitted by an emitting unit of the other vehicle through a detector, and positioning a display unit of the other vehicle according to the light spectrum; and
taking a photograph, by a camera, the positioned display unit, to obtain the first information displayed on the display unit of the other vehicle.

19. The method communication device according to claim 16, wherein said processing, by the processing unit, the first information, presenting the processed information to the user, and generating second information according to at least one of identification information of a current vehicle and user additional information as well as the first information comprises:
receiving at least one of text information, image information and audio information through an input interface, and generating the user additional information;
decoding two-dimensional code information in the first information through a decoder, so as to prompt the decoded information to the user; and
generating the second information for displaying according to at least one of the identification information of a current vehicle and the user additional information as well as the first information through a graphic processing unit GPU.

20. The method communication device according to claim 19, further comprising: storing, by a storage unit, a decoding dictionary.
